(19) United States
(12) Patent Application Publication
(10) Pub. No.: US 2011/0220483 A1
(43) Pub. Date: Sep. 15, 2011

(54) PROCESS FOR THE EXTRACTION OF SQUALENE, STEROLS AND VITAMIN E CONTAINED IN CONDENSATES OF PHYSICAL REFINING AND/OR IN DISTILLATES OF DEODORIZATION OF PLANT OILS

(76) Inventors: Jacques Margnat, Cassis (FR); Georges Cecchi, Marseille (FR); Olivier Guillon, Marseille (FR)

(21) Appl. No.: 13/002,844

(22) PCT Filed: Jul. 2, 2009
(86) PCT No.: PCT/FR2009/051287

§ 371 Date: May 2, 2011

(30) Foreign Application Priority Data
Jul. 7, 2008 (FR) 0854595

(51) Int. Cl. B01D 3/40

(52) U.S. Cl. 203/34; 203/46

(57) ABSTRACT

The invention describes a global method for extracting sterols, vitamin E, squalene and other vegetable hydrocarbons from deodorization distillates of vegetable oils. After esterification of the free fatty acids, followed by trans-esterification of the combined fatty acids (glycerides and sterides) with the same short alcohol, three successive distillations allow successive recovery of a first fraction of the hydrocarbons, the main fraction of alkyl esters, and then the heaviest alkyl esters with squalene. The third distillate will be used for producing squalene and a second fraction of hydrocarbons. The residue of the third distillation will be used for producing sterols and vitamin E. By using bio-ethanol, vegetable glycerol and the vegetable hydrocarbons of the method, with the method it is possible to extract each of the four unsaponifiables without any solvent of petroleum origin and claim the labels of products obtained by natural physical and chemical methods.

### TECHNICAL FIELD OF THE INVENTION

The object of the present invention is a method for simultaneous extraction of squalene, sterols and vitamin E (tocopherols and tocotrienols) contained in physical refining condensates and/or in distillates for deodorization of vegetable oils. It is located in the technical field of treatments of lipids.

### STATE OF THE ART

Vegetable oils contain between 0.5% and 2% of a portion which cannot be saponified, commonly called an “unsaponifiable” portion. The qualitative and quantative composition of this unsaponifiable varies according to the vegetable oils, but apart from a few exceptions, the family of sterols make the larger portion thereof, β-sitosterol always being the most abundant of them. Beside sterols, four families of products are found in smaller proportions: that of tocopherols and tocotrienols, such as triterpene alcohols, that of aliphatic alcohols and that of hydrocarbons.

Tocopherols (α, β, γ, δ) and tocotrienols (α, β, γ, δ) are particular phenols which are grouped under the name of Vitamin E, found in the human body divided into two classes: aliphatic hydrocarbons (paraffins and olefins) and terpene hydrocarbons (including squalene and carotene). In the particular case of olive oil, it is squalene which is by far the most significant compound by weight in its unsaponifiable portion. In the case of palm oil, carotene is one of the significant compounds of the unsaponifiable portion. All these compounds play at various degrees a significant role in different sectors which range from food to cosmetics, while transposing their beneficial effects toward vegetable cells, to those of the human body.

Sterols are known for their hypocholesterolemic properties. A large number of products notably margarines, containing phytosterols, are thus found on the market. Sterols are also used in the pharmaceutical industry for making steroids. Finally in cosmetics, they enter many formulations because of their properties which are both emulsifying, anti-inflammatory and anti-ageing.

Vitamin E like any phenol is a natural antioxidant, the antioxidant effects being exerted both in vivo and in vitro. Its vitamin effects, notably in the field of reproduction, have been known for a very long time. This is therefore a product used in the field of pharmacy, cosmetics and of food products.

Squalene is a hydrocarbon (C₃₀H₅₀) present in both the plant and the animal kingdom. As it is the precursor of cholesterol after its bio-epoxidation, it therefore indirectly plays a fundamental role in vivo in the structure of membranes of cells. Moreover it is present in an amount of 15% in human sebum. Its terpene nature gives it particular physico-chemical properties which make it an exceptional emollient. Under its stable totally hydrogenated form of perhydrosqualene (C₃₀H₆₂), it has moreover entered for more than 50 years a large number of cosmetic combinations because of its great compatibility with skin and of its emollients and moisturizing properties.

To this day, extraction of these families of unsaponifiables directly from vegetable oils is not economically reasonable because of their small percentage. Therefore, by-products of vegetable oils have to be used, in which these unsaponifiables have been concentrated. In the case of the chemical refining preferentially practiced on vegetable oils with slightly acid seeds (soya bean, sunflower, rape seed, ground nut, grape pips), fatty acids are mainly removed as soaps. In a last deodorization step, gas effluents called “deodorization distillates” or “DDs” according to their acronym are recovered by condensation. In the case of the deodorization step of the physical refining method preferentially practised on fruit vegetable oils (olive and palm oils), which may be very acid, the fatty acids are removed by distillation during deodorization which is thereby said to be neutralizing. During this step, gas effluents which are called “Oil Physical Refining Condensates” or “OPRCs” according to their acronym, are recovered by condensation.

These deodorization conditions (a vacuum of the order of 2 to 4 mbars, a temperature which may reach 250° C., steam stripping) not only promote the removal of odorous products and that of fatty acids (physical refining), which is sought, but also the stripping of products from the unsaponifiables depending on their relative volatility. Even if this stripping is only partial, the result is thus an appreciable concentration of unsaponifiable in DDs or OPRCs of the vegetable oils.

In DDs and OPRCs, the components of the unsaponifiable are of course accompanied by fatty acids which always form the majority components. Thus 25% to 50% of fatty acids are found for DDs, and 50% to 80% of fatty acids for OPRCs, but also more or less significant amounts of glycerides, mono-, di- and tri-glycerides) mechanically carried away in aerosols

The enrichment coefficients of the compounds of the unsaponifiable in the DDs or OPRCs, relatively to the initial oil, depend on the volatility of these different compounds, itself related to their boiling points. The lower the boiling point, the more the enrichment of this product in DDs and OPRCs will be significant. In the case of sunflower oil, the enrichment coefficients in DDs are for example 400, 250, 80 and 25 for non-squalene hydrocarbons, for squalene, for tocopherols and for sterols respectively. For the DDs of this oil, exploitable contents are thereby attained for extracting the components of its unsaponifiable with for example 5.9% non-squalene hydrocarbons, 4.9% squalene, 6.5% tocopherols and 11.8% sterols. In the case of palm oil, the enrichment coefficients in OPRCs are for example 50, 20, 13 and 10, for non-squalene hydrocarbons and non-carotene hydrocarbons, for squalene, for tocopherols and for sterols respectively. For OPRCs of this oil, 0.4% non-squalene hydrocarbons (and non-carotene hydrocarbons), 0.6% squalene, 0.5% tocopherols and 0.5% sterols are thereby attained. For soya bean which forms with palm oil the most abundant source, DDs are for example attained containing: 2.0% squalene, 10.8% tocopherols, 12.1% sterols. These percentages are extremely variable depending on the refining principle (either chemical or physical), on the nature of the refined oil and on the conditions of deodorization. Finally, it must be added that the sterols are found in DDs and OPRCs in free form and in a form esterified by fatty acids (sterides), forms for which the relative proportions are also very variable.

Taking into account the worldwide production of vegetable oils and the percentages of products carried away during deodorization, OPRCs and DDs form a raw material of choice for extracting unsaponifiables: squalene, other vegetable hydrocarbons, vitamin E (tocopherols and tocotrienols) and sterols.

The known methods for extracting the unsaponifiable portion mainly relate to the extraction of one or two unsaponifiables: that of sterols and that of vitamin E, for most of the time. If the extraction of squalene from OPRC and DD of olive oil is well known, no method seems to describe the extraction of squalene from byproducts of the refining of other vegetable oils. As for the hydrocarbons, other than squalene, contained in the vegetable oils, if their presence is described in the literature, to the knowledge of the applicant, no document seems to disclose an extraction method or the use of these hydrocarbons.

The major part of these methods applied for obtaining a concentrate of unsaponifiable products, is based on the more or less substantial removal of free or combined fatty acids, by making them more volatile or heavier. In order to separate sterols and vitamin E from the obtained concentrate, crystallization of sterols is generally used.

The most used esterification technique consists of reacting, in the presence of a catalyst, fatty acids from DDs or OPRCs with a short aliphatic alcohol, generally methanol, in order to convert them into fatty acid methyl esters, more volatile products than sterols and vitamin E. This method is for example described in patent documents U.S. Pat. No. 5,190,618 (Abdul G. et al.), U.S. Pat. No. 5,703,252 (Tracy K. et al.), and U.S. Pat. No. 5,627,289 (Lutz J. et al.). In these three documents where it is sought to respectively extract tocopherols and tocotrienols, tocopherols, tocopherols and sterols, the glycerides of DDs or OPRCs esterified beforehand with methanol are subject to transesterification of the glycerides into methyl esters, with the same alcohol, in the presence of a basic catalyst. The overall obtained methyl esters are then distilled in vacuo, leaving a rich residue of sterols and tocopherols. It is then generally proceeded with crystallization of sterols by using petroleum solvents such as hexane and methanol.

Certain techniques report the removal of fatty acids by molecular distillation, after prior esterification of the sterols with fatty acids, as sterides, which has the effect of making them heavier as regards their molecules and thus separable from tocopherols, by distillation of the latter. These techniques are for example described in patent documents U.S. Pat. No. 5,487,817 (Fizet C.) and U.S. Pat. No. 5,512,691 (Barnicki Scott D.). Thus, in the case of patent document U.S. Pat. No. 5,487,817 (Fizet C.), a fraction rich in fatty acids is obtained during a first molecular distillation. The obtained residue is then subject to a second molecular distillation with which it will be possible to obtain a distillate enriched with tocopherols, further containing fatty acids. The residue of this second distillation contains the major part of the sterols as sterides. In such methods, the essential of the hydrocarbons and a large part of the squalene are removed with the fatty acids.

A recent patent application WO 2008/008810 (WILEY ORGANICS Inc.), describes another approach for separate extraction of sterols and tocopherols by applying a method which involves saponification of DDs with methanolic potash. After adding water to the saponification product and cooling the hydro-alcoholic solution of soaps, the sterols directly crystallize from this solution and are separated by filtration. By acidification of the filtrate containing the soaps and tocopherols, the fatty acids are released which are separated by distillation. A tocopherol-rich residue is obtained. An alternative of this method consists of reducing the amount of produced soaps by proceeding with prior esterfication of fatty acids with methanol, followed by distillation of the obtained methyl esters. The distillation residue is then subject to saponification with methanolic potash. Sterols and tocopherols are then recovered in the same way as for direct saponification of DDs. In this method, squalene is very likely to be altered by isomerization during the acidification of the filtrate contained in the soaps. Moreover, a large portion of squalene is lost during the distillation of methyl esters, given their neighboring boiling points.

In the case of OPRCs of olives, relatively rich in squalene (5% to 15%), containing not many sterols and not much vitamin E, and naturally rich in fatty acids (50% to 80%), the fatty adds are converted into heavier molecules by esterification with glycerol in the form of pre-glycerides. The squalene is then separated from the triglycerides by distillation.

No technique of the prior art seems to describe the simultaneous obtaining of squalene, tocopherols and sterols from DDs or OPRCs. A simultaneous extraction method for vitamin E, phytosterols and squalene from palm oil is only known from patent document EP 1 394 144 (MALAYSIAN PALM OIL BOARD), comprising the steps of:
a) converting crude palm oil into methyl esters of palm oil;
b) three-stage short path distillation of the methyl esters of palm oils obtained in step (a) for obtaining phytonutrients;
c) saponification of the concentrate of phytonutrients from step (b);
d) crystallization of phytosterols; and
e) compartmenting vitamin E and squalene with solvents.

The method described in patent document EP 1 394 144 (MALAYSIAN PALM OIL BOARD), is specifically suitable for treating crude palm oil. The amount of vitamin E, phytosterols and of squalene obtained by this method is therefore small, which makes the obtained products relatively costly. In any case, all the methods known from the prior art at any moment or at another, involve the use of solvents of petroleum origin, which generates unquestionable sources of pollution.

The market is however keen on strong innovations in this sector of stereo-isomers of unsaponifiables. The market of natural vitamin E is marginal relatively to that of synthetic vitamin E. The ratio between synthetic vitamin E and natural vitamin E is estimated to be more than 80/20. And yet the advantages of natural vitamin E are well known and described in the literature. Synthetic vitamin E is a mixture of eight stereo-isomers of α-tocopherol. Only one of these stereo-isomers (12.5%) is similar to d-α-tocopherol, whence biological activity above that of natural vitamin E relatively to synthetic vitamin E. As regards the anti-oxidant activity, natural vitamin E is a mixture of four isomers, alpha, beta, gamma and delta tocopherol. The anti-oxidant activity of the isomers is δ>γ>β>α, giving a fundamental advantage to natural vitamin E as an antioxidant. It therefore appears to be particularly advantageous to reduce the extraction costs of natural vitamin E and to extract it with really natural processes so that its advantages of bioavailability and antioxidant activity may be valued.

As regards sterols, much less sensitive to thermal and oxidative aggressions than vitamin E, a wider range of raw materials from which they may be extracted is found. To DDs and OPRCs, tall-oils, biodiesel manufacturing residues and fatty acid manufacturing residues may be added. The capability of sterols to easily crystallize has the consequence that in most known methods of the prior art, they are separated by crystallization from a solution in petroleum solvents, by which they lose all possibilities of claiming a label of a natural product obtained by natural methods. These sterols therefore go against the present trend in food and cosmetic industries which is of going towards the use of elaborated products from natural or even “bio” methods.

For squalene and its hydrogenated form, squalane or perhydrosqualene, the main raw material still remains liver oil of small sharks from great depths, which contains depending on the species, from 40 to 80% of squalene in the oil. Several years ago, Europe begun to reduce fishing of deep sea species by drastic quotas, since these species breed very slowly and are threatened by intensive fishing. Whence the requirement of replacing squalene from shark origin with a renewable source and which preserves conservation of the species and of the environment For 15 years, OPRCs and DDs of olive oil have been giving the possibility of beginning to replace shark squalene with olive squalene. But the amounts of olive OPRCs and DDs are limited and will not be sufficient for replacing squalene of shark origin. It therefore appears to be particularly advantageous to develop the production of squalene from OPRCs and DDs of other vegetable oils, even if the extraction is made more difficult, considering the much lower squalene percentages.

Moreover, the trend of the cosmetics and food markets is to go towards the use of natural vegetable products. Thus bio food is developing strongly which is accompanied by labels regulating the natural origin of the products and requiring the application of physical and chemical production processes compatible with obtaining these labels. The market of sterols and of vitamin E has made a small step towards this concept by producing so-called “IP” (Identity Preserved) sterols and tocopherols, in other words not derived from GMOs (Genetically Modified Organisms). This is already a first beginning in the direction of sustainable development and preservation of the environment. However, vitamin E or sterols, even labeled as IP, which have been at one moment or at another subject to extraction processes in contact with hexane and methanol or other solvents of petroleum origin, cannot claim these labels of natural products which may be used in “bio” formulations.

Faced with this state of affairs, the main goal of the invention is to propose a method with which squalene, sterols and vitamin E may be extracted simultaneously in order to better upgrade the value of these unsaponifiables which is not the case in known industrial methods from the prior art.

Another goal of the invention is to propose a method with which four unsaponifiables: squalene, vegetable hydrocarbons, vitamin E and sterols, may be produced simultaneously with a global method from DDs and OPRCs of vegetable oils.

The goal of the invention is also to be able to extract the aforementioned unsaponifiables by mild chemistry techniques, without using petroleum solvents, in order to be able to claim labels of natural products.

Further, the occurrence of a new economical constraint from the industrial development of biodiesel has to be emphasized. This new industry has actually widely contributed to increasing the price of oils and of their byproducts. In order to maintain or lower production costs of market unsaponifiables, it is therefore necessary to turn towards better use of the raw material. The goal of the invention is further to propose an industrial global method with which different components of the unsaponifiable of vegetable oils may be extracted and therefore their production costs may be reduced.

### DISCLOSURE OF THE INVENTION

The solution proposed by the invention is a method for extracting squalene, sterols and vitamin E contained in physical refining condensates and/or in deodorization distillates of vegetable oils, said method comprising the following steps:
a) conversion of the fatty acids, the glycerides and the sterides contained in said condensate and/or said distillates, in order to obtain a product based on alkyl esters, squalene, vegetable hydrocarbons, sterols and vitamin E,
b) staged distillation of the product obtained in step a) established for recovering a concentrate of sterols and of vitamin E on the one hand and a concentrate of alkyl esters, squalene and vegetable hydrocarbons on the other hand,
c) crystallization of the concentrate of sterols and vitamin E obtained in step b), in a mixture with hydrocarbons, in order to recover the sterols on the one hand and a concentrate of vitamin E in solution in said hydrocarbons on the other hand
d) distillation of the vitamin E concentrate in solution in the hydrocarbons obtained in step c), established for recovering vitamin E,
e) conversion of the alkyl esters of the concentrate obtained in step b) into triglycerides followed by a distillation established for separating said triglycerides from squalene and from vegetable hydrocarbons,
f) distillation of the product obtained in step e), established for extracting squalene from the vegetable hydrocarbons.

According to a particularly advantageous feature of the invention, the vegetable hydrocarbons separated at the end of step f) are used for participating in the crystallization of the sterols in step c).

The staged distillation of step b) is preferentially accomplished by carrying out:
b.1) a first distillation established for extracting a fraction of the vegetable hydrocarbons and a fraction of the alkyl esters,
b.2) a second distillation established for extracting the majority of the alkyl esters from the residue obtained in step a),
b.3) a third distillation established for carrying away the residual alkyl esters, the squalene and the residual vegetable hydrocarbons, without carrying away the sterols and vitamin E which are less volatile.

The first distillation is advantageously accomplished on a packed column representing the equivalent of twenty theoretical plates, in a vacuum comprised between 3 mbars and 10 mbars, preferentially between 4 mbars and 7 mbars, at a heating temperature comprised between 160° C. and 180° C., and at a column head temperature comprised between 120° C. and 150° C., preferentially between 140° C. and 145° C. The second distillation is advantageously accomplished on a packed column representing the equivalent of ten theoretical plates, in a vacuum comprised between 10 mbars and 40 mbars, preferentially between 20 mbars and 30 mbars, at a heating temperature comprised 220° C. and 250° C., preferentially 230° C., and at a column head temperature comprised between 180° C. and 220° C., preferentially between 200° C. and 205° C. The third distillation is advantageously accomplished on a packed column representing the equivalent of ten theoretical plates, in a vacuum comprised between 1 mbar and 10 mbars, preferentially between 2 mbars and 5 mbars, at a heating temperature comprised between 220° C. and 260° C., preferentially between 240° C. and 250° C., and at a column head temperature comprised between 200° C. and 250° C., preferentially between 220° C. and 230° C.

Light hydrocarbons from the first distillation may be recovered by further providing the steps of:
g.1) conversion of the fraction of the alkyl esters extracted in step g.1) into triglycerides,
g.2) distillation of the product obtained at the end of step g.1) established for separating said triglycerides from vegetable hydrocarbons. The latter may be combined with the hydrocarbons separated at the end of step f) the whole being used for crystallizing the sterols in step c).

Obtaining the alkyl esters (step a) is advantageously accomplished via:

esterification of fatty acids with a short alcohol, selected from primary and secondary C₁-C₃ alcohols, and in the presence of an acid catalyst. This esterification is advantageously accomplished under the following conditions:
an amount of acid catalyst of less than 0.1% relatively to the mass of the condensates and/or of the distillates to be esterified,
the reaction temperature is less than 95° C.,
the esterification alcohol is in molar excess in a ratio of more than 5 relatively to the fatty acids,
the acid catalyst is totally neutralized at the end of the esterification

a trans-esterification of the glycerides and of the sterides with a short alcohol, selected from primary and secondary C₁-C₃ alcohols, and in the presence of a basic catalyst. This trans-esterification is advantageously carried out under the following conditions:
the reaction temperature is less than 100° C.,
the basic catalyst is totally neutralized at the end of trans-esterification.

And according to a preferred feature of the invention, the trans-esterification and esterification mentioned earlier are both carried out with ethanol of vegetable origin. By using bio ethanol as a short alcohol, vegetable glycerol and vegetable hydrocarbons stemming from the process, the extraction method, object of the invention, may be carried out industrially, without any solvent of petroleum origin. With this feature it is possible to claim the labels characterizing products obtained by natural physical and chemical processes on the one hand and to claim their use as natural products in combination with products which claim the “bio” labels, on the other hand.

For extracting and purifying squalene, prior to step f), said squalene and the hydrocarbons separated at the end of step e) may be saponified for removing optional residual saponifiable products. In any case, step f) is advantageously carried out by distillation on a column with a height equivalent to twenty theoretical plates, in a vacuum comprised between 2 mbars and 10 mbars, preferentially between 4 mbars and 8 mbars, the product to be treated being injected into the column head at a temperature comprised between 200° C. and 230° C., preferentially 215° C., nitrogen being injected simultaneously at the column bottom for counter-current operation. The distilled hydrocarbons further containing a squalene fraction, may be reinjected into the column until a percentage of squalene of less than 10% is obtained.

According to still another advantageous feature of the invention, a winterization step is carried out on the squalene obtained at the end of step f).

As regards the extraction and purification of vitamin E, the distillation of step d) is advantageously carried out on a packed column representing the equivalent of ten theoretical plates, in a vacuum comprised between 0.2 mbars and 5 mbars, preferentially 1 mbar, at a heating temperature comprised between 200° C. and 240° C., preferentially 220° C., and at a column head temperature comprised between 180° C. and 220° C., preferentially 200° C.

### DESCRIPTION OF THE FIGURES

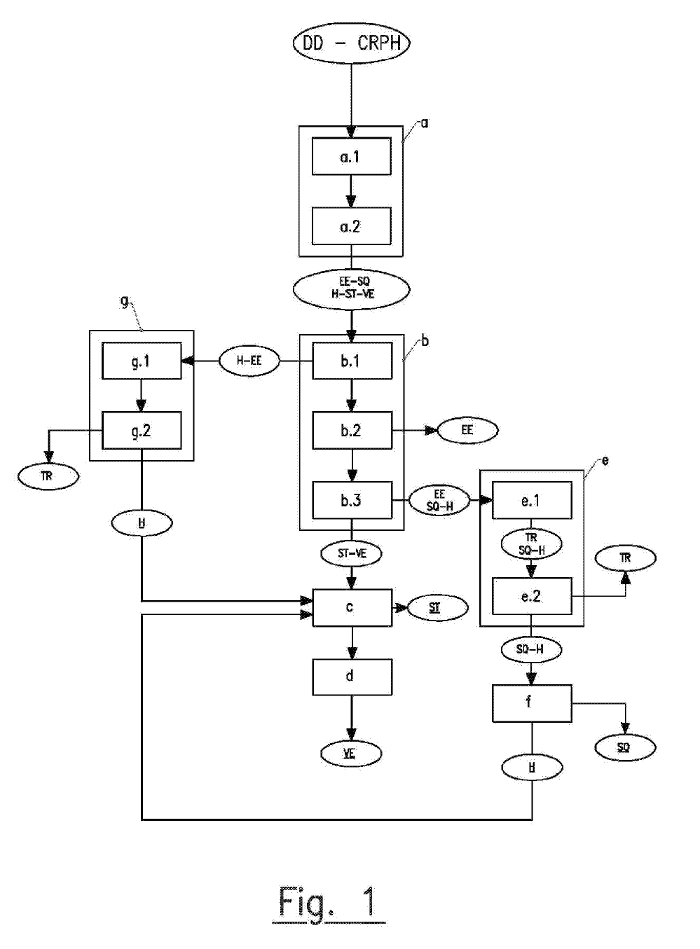

Other advantages and features of the invention will become better apparent upon reading the description of a preferred embodiment which follows, with reference to the appended drawing, made as an indicative and non-limiting example and wherein FIG. 1 schematically illustrates different steps of the method according to the invention.

### EMBODIMENTS OF THE INVENTION

Considering the world production of vegetable oils and the percentages of stripped products during deodorization, deodorization distillates (DDs) from chemical refining and condensates from physical refining (OPRCs) of vegetable oils form a raw material of choice for extracting unsaponifiables, the present invention describing the extraction thereof: squalene, vitamin E (tocopherols and tocotrienols), sterols and optionally other vegetable hydrocarbons. All the vegetable oils contain these four families of unsaponifiables in more or less large amounts. The most volatile (squalene and vegetable hydrocarbons) were concentrated relatively to the sterols and to vitamin E during deodorizations of the physical refining and of the chemical refining of vegetable oils. All the DDs or OPRCs of oils may be used, a selection may however be made either for the traceability of the materials, or for obtaining a specific unsaponifiable in a stronger concentration than another one. Sunflower condensates for example contain a very strong proportion of d-α-tocopherol, while palm oil condensates contain a very strong proportion of tocotrienols, (80%) as compared with tocopherols (20%). Residues of grape pip oil may also be sought if the intention is to obtain a good concentration of tocotrienols. Condensates of olive oil, of olive cake or those of amaranth oil (even richer in squalene than olive oil) will be sought if priority is given to squalene. Fractionations of palm oil OPRCs existing on the market may also be used as a more concentrated source of vegetable hydrocarbons. Regardless of whether the OPRCs and DDs are used by oil origin or as a mixture, depending on the sought result, the method is applied to condensates of oils of any vegetable origins.

However, interesting concentrations of unsaponifiables may be found in other byproducts of the exploitation of vegetable oils. This is notably the residue from the making of biodiesel, when the methyl esters obtained by transesterification of the oils with methanol are distilled. But in this case, the hydrocarbons, including squalene, are generally distilled with methyl esters, and vitamin E risks being degraded in the process. This also applies during the making of fatty acids by pressurized hydrolysis of vegetable oils. In this case, the distillation of fatty acids will not only cause a loss of hydrocarbons, including squalene, but also a significant loss of vitamin E, because of the very severe conditions of the hydrolysis. Only the sterols are found concentrated or non-destroyed at the end of the process. Certain biodiesel production units perform a basic physical refining of the oil, before esterification with methanol. This type of residue is an integral part of the raw materials retained for our invention.

An embodiment of each step of the method, object of the invention, will now be described in more detail, with reference to FIG. 1, wherein: EE=Ethyl Ester (alkyl ester); SQ=Squalene; H=Hydrocarbon; ST=Sterols; VE=Vitamin E; TR=Triglyceride.

Step a)—Obtaining Alkyl Esters.

With this step, fatty acids, glycerides and sterides contained in DDs and/or OPRCs, may be converted in order to obtain a product based on alkyl esters, squalene, vegetable hydrocarbons, sterols and vitamin E. In particular, this step involves the conversion of free fatty acids and those combined as alkyl esters under conditions avoiding isomerization of the squalene, thereby allowing a market squalene to be obtained.

The esterification and trans-esterification of fatty acids from byproducts of the refining of vegetable oils (DDs and OPRCs) have been reactions which have been known for a long time. However, the risks of degradation of squalene during esterification reaction are not described. The Applicant has now defined esterification and trans-esterification conditions which will not allow degradation of the squalene

Squalene is actually a very reactive molecule because of the presence of six double bonds and of its particular structure of terpene nature which may give rise, in the presence of protons, to the formation of relatively stable tertiary carbonations, which may either evolve towards the formation of geometrical and positional isomers, or towards the formation of cyclic isomers. Both of these families of isomers contribute towards reducing the purity of squalene. During the hydrogenation of squalene into squalane, the positional isomers and the geometrical isomers which only concern the position of the double bond on the carbon chain and its geometrical conformation, respectively, will be converted into squalane (or perhydrosqualene) by hydrogenization. On the other hand, cyclic isomers which are formed irreversibly, will give by hydrogenation a generally mono-cyclized squalene which will contribute to the overall purity of the squalane (perhydrosqualene). A goal of the invention is therefore to define conditions with which the production of isomers may be avoided.

According to the invention, the esterification (step a.1) is performed with a short alcohol, selected from primary and secondary alcohols with carbon condensation comprised between one and three, preferably ethanol of vegetable origin, in the presence of an acid catalyst selected from acid and para-toluene-sulfonic acid (PTSA). One skilled in the art may however use other alkyl alcohols such as methanol, propanol or another alcohol, in order to carry out the esterification step. The acid catalyst, a donor of protons, is dangerous as regards the risk of isomerization which has to be avoided. The Applicant has shown that PTSA further causes formation of squalene isomers. Sulfuric acid will therefore be preferred for the esterification. The desirable acid catalyst concentration is 0.1% at most relatively to the mass of OPRCs or DDs to be esterified

The Applicant has also shown that the more esterification alcohol there was relatively to the fatty acids, less there was any formation of squalene isomers, because of the dilution of the acid catalyst. The esterification method described by Martinenghi with introduction of methanol vapors into fatty acids, in the presence of an acid catalyst, is the one which created the most squalene isomers, even with a temperature of 70° C. In order to avoid the formation of isomers, the esterification alcohol preferentially is in molar excess in a minimum ratio of 5, and preferentially 10, relatively to the fatty acids. As the temperature is a factor facilitating isomerization of squalene, esterification at a temperature below 95° C., preferentially below a temperature comprised between 80° C. and 90° C. with alcohol reflux, was retained.

The Applicant has further shown that the acid catalyst had to be completely neutralized in order to prevent residual acidity from causing isomerization of squalene during the subsequent steps of the method performed at higher temperatures. This neutralization of the acid catalyst is accomplished with ethanolic soda or ethanolic potash. The excess alcohol is then totally evaporated as well as the water from the esterification.

The thereby obtained anhydrous product is then subject to trans-esterification (step a.2) in the presence of a short alcohol identical with that of the esterification of fatty acids, selected from primary and secondary alcohols, with a carbon condensation comprised between one and three, preferably ethanol of vegetable origin, in the presence of a basic catalyst, preferably sodium ethylate, in order to convert the pre-existing glycerides into ethyl esters of fatty acids. Other alkyl alcohols (methanol, propanol, . . . ) may however be used for converting the pre-existing glycerides into other alkyl esters of fatty acids (methyl esters, propyl esters, . . . ). During trans-esterification, the sterols combined in the sterides are found in free form. After total neutralization of the basic catalyst with a strong acid (H₂SO₄ or HCl), the ethanol is evaporated and the decanted glycerol is discarded. The product is then washed to neutrality. The trans-esterification reaction is accomplished at a temperature below 100° C., preferentially at a temperature comprised between 80° C. and 90° C. under alcohol reflux, Bio ethanol will be the alcohol preferentially used with sulfuric acid as a catalyst, so as to be able to claim a label of products obtained by natural processes, as described later on.

Step b)—Staged Distillation of the Product Obtained at the End of Step a.

With this step it is possible to recover a concentrate of sterols and of vitamin E on the one hand and a concentrate of alkyl esters, squalene and vegetable hydrocarbons on the other hand. In practice, the product stemming from step a) is subject to three successive fractionated distillations at different temperatures, under mild conditions with which it is possible to avoid degradation of the unsaponifiables during these steps, especially vitamin E, particularly during the third distillation. A first distillation will give the possibility of extracting a fraction of the vegetable hydrocarbons (except squalene) and a fraction of the alkyl esters. A second distillation will allow extraction of the larger portion of the alkyl esters of the residue obtained in step a), without carrying away any squalene. A third distillation will allow squalene to be carried away with the heavier residual alkyl esters, without carrying away vitamin E and sterols which are clearly less volatile.

### Step b.1)—First Distillation.

The alkyl esters are subject to a first distillation of the hydrocarbons present in the esterified OPRCs and DDs. The goal is to distil the lighter hydrocarbons corresponding to a C₈-C₁₅ cuts, which are very odorous, or even irritating, also certainly because of the presence of aldehydes from the oxidation of the fats. A second goal is to obtain a fraction of vegetable hydrocarbons, not having the drawbacks of the first fraction, which may be used during the process, as a replacement for petroleum solvents, as explained subsequently in the Patent.

This first distillation of hydrocarbons is achieved by fractionated distillation on a column filled with a packing of the metal mesh type with a height equivalent to twenty theoretical plates. With a distillation carried out at a heating temperature comprised between 160° C. and 180° C. and a column head temperature comprised between 120° C. to 130′ at the column head and a vacuum comprised between 3 mbars and 10 mbars, preferentially between 4 mbars and 7 mbars, it is possible to distil the lightest hydrocarbons, mainly C₈-C₁₅ hydrocarbons without carrying away alkyl esters. But this fraction represents less than 20% of the vegetable (non-squalene) hydrocarbons present in the OPRCs and DDs and a significant portion of the hydrocarbons would then be lost during the second distillation of the esters, by being removed with the distillate. It is therefore preferred to carry out distillation of the hydrocarbons with a temperature comprised between 120° C. and 150° C., preferentially between 140° C. to 145° C. at the column head and a vacuum from 4 to 7 mbars, with which more than 50% of the vegetable hydrocarbons (non-squalene) present in the OPRCs and ODs may be recovered and only about 20% of light alkyl esters may be carried away in the distillate. The obtained hydrocarbon fraction consists of hydrocarbons ranging from C₈ to C₂₂, with a majority fraction consisting of hydrocarbons ranging from C₁₅ to C₂₂. The distillate of said distillation of hydrocarbons at 140° C.-145° C. will be taken again in step g) described hereafter for purifying the vegetable hydrocarbons.

### Step b.2)—Second Distillation.

The residue of the first distillation of hydrocarbons (step b.1) is then subject to a second fractionated distillation, in a system continuously operating in vacuo comprising a scraped or falling film evaporator equipped with a fractionation column filled with packing which will allow separation of the largest portion of ethyl esters, without carrying away squalene, vitamin E and sterols. As squalene is more volatile than vitamin E and the sterols, both of these products are not carried away when squalene is not carried away.

According to the invention, this separation is performed on a column with a height equivalent to ten theoretical plates, in a vacuum comprised between 10 mbars and 40 mbars, preferentially between 20 mbars and 30 mbars, by bulk heating of the alkyl esters to a temperature comprised between 220° C. and 250° C., preferentially 230° C., with a column head temperature comprised between 180° C. and 220° C., preferentially between 200° C. and 205° C. Beyond these temperatures, there is a risk of reforming sterides and/or of carrying away a lot of squalene. Regular refluxing inside the column is advantageously provided so as not to carry away squalene. This step allows the larger portion of the esters to be carried away. The distillate of the second distillation essentially consists of alkyl esters and contains less than 1% squalene, sterols and vitamin E. The residue of said second distillation essentially contains the heaviest residual alkyl esters and the remainder of the unsaponifiables.

### Step b.3)—Third Distillation.

The residue from step b.2) is subject to a third distillation in vacuo. As squalene and the heaviest alkyl esters are very difficult to separate by distillation, the third distillation is intended to distil together these residual esters and squalene, while leaving in the residue, sterols and vitamin E which are less volatile. In this third distillation, the temperature is limited so as to avoid thermal isomerization of the squalene. A too high distillation temperature also promotes partial reformation of sterides by trans-esterification of the sterols with ethyl esters, as well as the thermal conversion of these said sterides into sterenes with release of fatty acids, causing a loss of sterols. Therefore the drawbacks of batch distillations (a long dwelling time and interactions between vapors and liquid to be crossed) have to be avoided. Distillation tests on a molecular distillation reactor have not given the possibility of obtaining the desired separation.

In order to avoid these drawbacks, as well as a possible loss of vitamin E, the distillation device comprises a scraped or falling film evaporator equipped with a fractionation column filled with packing. The distillation system used is the same as the one used during the second distillation. Said distillation device operating with a thin liquid layer in the scraped or falling film reactor, not only promotes instantaneous evaporation of the vapors but also a reduced contact time with the heating system, by which vapors which have not undergone any prolonged thermal stress may be sent onto the filled column. According to the invention, this third distillation is achieved with a product heated to between 220° C. and 260° C. preferentially between 230° C. and 245° C. a column head temperature comprised between 200° C. and 250° C. preferentially between 220° C. and 230° C. in a vacuum comprised between 1 mbar and 10 mbars, preferentially between 2 mbars and 5 mbars and a packing representing ten theoretical plates. Regular refluxing inside the column is required so as not to carry away tocopherols and vitamin E. With this third distillation, it is possible to obtain a distillate containing squalene with the heaviest alkyl esters on the one hand and a residue mainly containing sterols and vitamin E on the other hand.

### Step c). Crystallization of the Sterols.

The residue of the third distillation of the alkyl esters (step b.3), highly concentrated in sterols and vitamin E, will be used for extracting sterols and vitamin E. After concentration of the sterols and of vitamin E, certain methods use prior purification by saponification. This saponification generally accomplished in a methanol or ethanol medium requires significant dilution of the formed soaps, therefore the application of significant amounts of solvents. This saponification step is avoided in the present method. Indeed, trans-esterification of the triglycerides after esterification of the fatty acids (step a) and third distillation of the esters at the same time as that of squalene (step b.3), have allowed removal of the quasi totality of the triglycerides and of the esters. The suppression of the saponification step thus allows simplification of the method and minimization of the losses of unsaponifiables retained in the soaps.

The concentrate of vitamin E and the sterols obtained in the residue of the third distillation of the esters (step b.3) is then directly subject to crystallization, without passing through a saponification step. Known methods recommend putting the concentrate into solution in hexane, in the presence of ethanol or methanol and water. These methods are widely described in the literature relating to extraction of sterols and may of course be used for separating sterols and vitamin E stemming from the present method.

A particularly remarkable feature of the invention is to be able to replace this crystallization from a solvent medium of petroleum origin with crystallization from a mixture with vegetable hydrocarbons generated by the method described earlier. The concentrate of sterols and vitamin E has thus been dissolved in vegetable hydrocarbons in a ratio from 1 to 4. The mixture is then heated to 80° C. in order to dissolve the solid compounds into the vegetable hydrocarbons. The obtained solution is then gradually cooled (5° C. to 10° C. per hour) down to room temperature, 25° C., with weak stirring, so as to promote optimum development of crystals. After a night of maturation, the crystals are filtered by incorporating 2% silica (dicalite commercial grade). During this first winterization, 95% of the sterols put into play are recovered. By washing the filtration cake with vegetable hydrocarbons and second winterization at a lower temperature of 0° C., it is possible to obtain a yield above 98%. The product is then melted, and then filtered in vacuo in order to separate dicalite and in order to recover the sterols by filtration. This crystallization of the sterols was accomplished without adding any ethanol or any ethanol and water, given the significant yields obtained as soon as the first winterization.

### Step d). Extraction and Purification of Vitamin E.

After crystallization of the sterols (step c), the filtrate contains vitamin E, a small percentage of squalene, ethyl esters and impurities, in solution in vegetable hydrocarbons. This filtrate is then subject to distillation in a reactor of the type used in steps b.2 and b.3: scraped film evaporator equipped with a column with ten theoretical plates. The thin film configuration and the reduced heating time are required for avoiding degradation of vitamin E. The evaporator is heated to a temperature comprised between 200° C. and 240° C., preferentially 220° C. The column head temperature is between 180° C. and 220° C., preferentially 200° C. Reflux of the esters is used in a vacuum comprised between 0.2 mbars and 5 mbars, preferentially 1 mbar. The major portion of the hydrocarbons, squalene and esters is thereby distilled. The distillate is then recycled in the process for obtaining vegetable hydrocarbons. The residue, very rich in vitamin E will be used as such or will then be purified according to techniques known to one skilled in the art, for example by having it pass into an ion exchange column. Vitamin E may also be concentrated by methods known to one skilled in the art and in particular by having it pass over anionic resins and by molecular distillations.

Step e)—Conversion of Alkyl Esters and Recovery of Squalene and Vegetable Hydrocarbons.

The distillate from the third distillation of the esters (step b.3) not only contains squalene and the heavier alkyl esters which are the majority products, but also hydrocarbons. The latter have a carbon condensation mainly comprised between C₁₇ and C₂₂ and represent 10% to 20% of the amounts of squalene depending on the origins of the DDs and OPRCs. These three families of products globally having close volatilities will be separated according to the following process.

The distillate from the third distillation (step b.3) is first subject to trans-esterfication (step e.1) with glycerol, preferentially vegetable glycerol, in order to convert the alkyl esters into triglycerides. Said trans-esterification reaction, catalyzed by 0.05% of soda lye at 50%, is conducted at a heating temperature comprised 180° C. and 230° C., preferentially between 200° C. and 210° C., in a vacuum comprised between 20 mbars and 40 mbars, preferentially 30 mbars, in a reactor equipped with a thermo-controlled reflux column with which the released short alcohol may be distilled while trapping the glycerol. The squalene and the hydrocarbons are then separated from the triglycerides (step e.2) by distillation at a heating temperature comprised between 220° C. and 260° C., preferentially between 240° C. and 250° C., and a head temperature comprised between 200° C. and 250° C., preferentially between 220° C. and 230° C., with a vacuum comprised between 0.2 mbars and 5 mbars, preferentially 1 mbar, in the case of batch distillation. This reaction may also be conducted by molecular distillation with a temperature comprised between 220° C. and 230° C. and a vacuum of less than 0.1 mbars.

### Step f). Extraction and Purification of Squalene.

The squalene and the hydrocarbons obtained at the end of step e) are optionally saponified in order to remove possible residual saponifiable products.

The squalene may further contain up to 10% to 20% of residual hydrocarbons, the major portion of which have a smaller molar mass than that of squalene. In order to increase the purity of squalene, the squalene obtained at the end of step e), or possibly at the end of the saponification step, is separated from residual hydrocarbons by distillation and preferentially by stripping with nitrogen. The latter is achieved on a column with a height equivalent to twenty theoretical plates in a vacuum comprised between 2 mbars and 10 mbars, preferentially between 4 mbars and 8 mbars. The product is injected into the column head, at a temperature comprised between 200° C. and 230° C., preferentially 215° C., while nitrogen is simultaneously injected at the bottom of the column for counter-current operation. In this way, high purity squalene is obtained. The distilled fraction mainly contains hydrocarbons with a main carbon condensation comprised between C₁₇ and C₄₂. Said fraction of hydrocarbons may further contain between 20% and 30% of squalene. It may therefore be subject to a second and third passage in the column in order to better separate the vegetable hydrocarbons, which will contain at the end of the operation, a squalene percentage of less than 10%.

Depending on the origin of the vegetable oil, the obtained squalene after stripping may further contain waxes and paraffins which were not able to be discarded by distillation. A winterization step is then required. Said winterization involves cooling to a temperature between 0° to +5° C., in a reactor slightly stirred for ripening the crystals. The latter are separated from the liquid portion formed by squalene by filtering on a filter press, after adding 2% silica (commercial grade dicalite), intended to facilitate filtration.

The thereby purified vegetable hydrocarbons have a flash point above 100° C. They have a cloud point of 0° C. and a pour point of −5° C. They are therefore capable of being directly used as a solvent for participating in the crystallization of sterols (step c) or mixed with the fraction obtained during the first distillation of the alkyl esters (step b.1), after purification as described hereafter in step g).

### Step g). Extraction and Purification of Vegetable Hydrocarbons.

The fraction of hydrocarbons extracted by distillation during step b.1), before the distillation of the alkyl esters, has a carbon condensation mainly ranging from C₈ to C₂₂. This fraction contains of the order of 20% of alkyl esters. As the separation of these vegetable hydrocarbons and of these alkyl esters proves to be impossible by distillation, said fraction of hydrocarbons will be subject to an inter-esterification step (step g.1) with glycerol, preferably vegetable glycerol, in order to convert the alkyl esters into triglycerides. The reaction is carried out in the presence of 0.005% to 0.01% of a basic catalyst (soda or potash lye at 50%), at a temperature located between 180° C. and 230° C., preferentially between 200° C. and 210° C., in a vacuum comprised between 40 mbars and 60 mbars, preferentially 50 mbars, in a stirred reactor, equipped with a thermo-controlled reflux column, with which the released short alcohol may be distilled while trapping the hydrocarbons and the glycerol. This reaction is carried out with a slight 5% excess of hydroxyl functions relatively to the carboxylic groups.

Said inter-esterification product of the vegetable hydrocarbons is then distilled in order to separate the triglycerides from said hydrocarbons (step g.2). This distillation is advantageously carried out in two phases. A first phase allows distillation of the low molecular mass hydrocarbons (mainly with a carbon condensation comprised between C₈ to C₁₅) which represent about 20% of the fraction of hydrocarbons. This fraction will be removed since it is very odorous, irritating and has a flash point below 100° C. This fraction is obtained by distillation on a column filled with a packing of the stainless steel mesh type, having a height equivalent to ten theoretical plates, and a maximum temperature of 125° C. at the column head, in a vacuum from 5 to 7 mbars. A second phase enables subsequent distillation on a same column of the remainder of the hydrocarbons at a column head temperature of 215° C. The distillate consists of hydrocarbons with chain lengths greater than those of dodecane and is much less odorous. In this way a fraction of hydrocarbons with a carbon condensation from C₁₂ to C₂₂ is obtained.

The second fraction of vegetable hydrocarbons obtained in this step g) will then be mixed with the fraction of vegetable hydrocarbons obtained at the end of step f) in order to thereby obtain a fraction of vegetable hydrocarbons having a main carbon condensation mainly ranging from C₁₂ to C₂₂. These vegetable hydrocarbons have a cloud point below 0° C. and a pour point below −5° C., which makes them capable of being used as solvents for crystallization of sterols, subsequently in the method.

Obtained by physical processes (distillation) and chemical processes (esterification and inter-esterification, glycerolysis) considered as natural processes, these vegetable bio solvents may be used instead and in place of petroleum solvents in order to claim labels of natural products compatible with “bio” origin products. Taking into account the relatively small amount of these vegetable hydrocarbons in DDs and OPRCs, it is necessary to prepare a sufficient stock of said hydrocarbons in order to be able to proceed with a suitable dilution of the fraction rich in sterols.

To summarize, the method, object of the invention, preferentially induces the making up of a cut of vegetable hydrocarbons recovered during the first distillation (step g), as well as during purification of the squalene by stripping (step f). Indeed, a particularly remarkable feature of the invention is to use these vegetable hydrocarbons during the process in order to advantageously replace the petroleum solvents for the extraction of sterols and vitamin E (step c).

The present invention will now be illustrated with more details with reference to the following specific examples. These examples are not limited.

### Example 1

### Esterification by Bio-Ethanol of a Deodorization Distillate of Sunflower Oil—Step a)

In a 5 liter flask, 1,000 g of oleic sunflower DD is introduced, which has the following composition:
saponifiable portion: free fatty acids: 38%, triglycerides: 25.8%, fatty acid esters: 7%;
unsaponifiable portion: 29.2%. This unsaponifiable portion consists of sterols and triterpene alcohols for 38.6%, squalene: 19.9%, vitamin E: 6.5%, non-squalene hydrocarbons: 29.8%, unidentified products and impurities: 5.2%.

This condensate is mixed with 620 grams of anhydrous ethanol i.e. a molar ethanol excess relatively to the fatty acids of 10. 1 gram of concentrated sulfuric acid is added, i.e. 0.1% relatively to the mass of loaded condensate. The stirred flask is purged several times with nitrogen and then heated to 90° C. The reaction is conducted for 4 hours with reflux of ethanol. After cooling, the sulfuric acid is neutralized with a 0.5 N ethanolic soda solution with stirring, for 30 minutes. The excess ethanol and the reaction water are distilled under atmospheric pressure, and then under a vacuum of 50 mbars and at a temperature of 100° C. The final product has an acid number of 0.7 and the squalene was not isomerized.

### Example 2

### Esterification by Bio-Ethanol of a Sunflower DD—Step a)

500 g of sunflower DD identical with those of Example 1 are introduced into a 1-liter autoclave. This condensate is mixed with 154.9 grams of anhydrous bio-ethanol, i.e. a molar ethanol/fatty acids excess of 5. 0.5 g of concentrated sulfuric acid are added, i.e. 0.1% relatively to the mass of loaded condensate. After several purges with nitrogen, the reactor is gradually heated to 90° C., with stirring for one hour, the pressure reached being 2.5 bars. After cooling the reactor, the reaction medium is neutralized with a 0.5 N ethanolic soda solution, for 30 minutes with stirring. The ethanol is then distilled at atmospheric pressure and then in a vacuum of 50 mbars and at a temperature of 100° C. at the end of the distillation, in order to remove the esterification water. An anhydrous product is obtained with an acid number of 0.8 and the squalene was not isomerized.

### Example 3

### Ethanolysis of a Sunflower DD Esterified with Bio-Ethanol—Step a)

In a 5-liter flask, 1,000 grams of the esterified product in the example 1 are introduced, which contain 25.8% of triglycerides and 11.2% of sterols present in an esterified form, which corresponds to 1 mole of ester. 20 moles of anhydrous bio-ethanol (molar excess of 20) i.e. 920 grams of bio-ethanol are added, in which 1% by weight of sodium has been dissolved beforehand in order to generate sodium alcoholate in situ. The flask is then heated with stirring, with reflux of ethanol, to 80° C., for 2 hours. The sodium present in the form of sodium ethylate is then neutralized with a 0.5 N sulfuric acid solution. The ethanol is first distilled under atmospheric pressure, and then under a reduced pressure of 50 mbars. The sodium sulfate formed during neutralization is removed by washing with water. All the glycerides were converted into ethyl esters as well as the pre-existing sterides, which causes effective release of the sterols. Three washes are then carried out with distilled water at 80° C. so as to remove the traces of mineral acidity present in the medium.

### Example 4

### Ethanolysis of a Sunflower DD Esterified by Ethanol—Step a)

200 grams of DD esterified in example 2 are introduced into a 500 mL autoclave, which corresponds to about 0.2 moles of ester, taking into account the content of triglycerides and sterides of this DD. 46 grams of anhydrous ethanol are then introduced, which corresponds to a molar excess of 5 relatively to the number of moles of esters to be ethanolyzed. 1% by mass of sodium was dissolved beforehand in ethanol. The reaction is conducted at 90° C., for 2 hours, under a pressure of 2.6 bars. The sodium present in the form of sodium ethylate is then neutralized with a 0.5 N sulfuric acid solution. The ethanol is first distilled under atmospheric pressure, and then under a reduced pressure of 50 mbars. The sodium sulfate formed during neutralization is removed by washing with water. All the glycerides were converted into ethyl esters as well as the pre-existing sterides, which causes effective release of the sterols. Three washes are then carried out with distilled water at 80° C. so as to remove the traces of mineral acidity present in the medium.

### Example 5

### Distillation of Light Hydrocarbons from a Sunflower Oil DD—Step b.1)

In a thermostated ampoule with a capacity of 1 liter, 800 grams of esterified and ethanolyzed sunflower DD, from Example 3, are introduced, which then have the following composition: fatty acid ethyl esters 562.4 grams (70.3%), sterols and triterpene alcohols 90.4 grams (11.3%), squalene 46.4 grams (55.8%), total tocopherols 15.2 grams (1.9%), free fatty acids 4 grams (0.5%), non-squalene hydrocarbons, 69.6 grams (8.7%) impurities (oxidative degradation products, . . . ) 12 grams (1.5%).

The product is introduced via a valve on a discharger above the packing of a stripping column with a useful height of 25 cm of Sulzer packing type BX with a diameter DN of 25 mm. The system is used in a vacuum of 4 mbars and has twenty theoretical plates. The flow rate is 200 grams per hour. Nitrogen is injected at the column base, before packing. The column head temperature is 145° C. The distilled product (39.1 grams) contains 69.8% of non-squalene hydrocarbons, 21% of fatty acid ethyl esters, 2.8% of free fatty acids, 5.4% of squalene and 1% of volatile impurities. The residue (761 grams) consists of 72.8% of fatty acid ethyl esters and represents 95.1% of the product before stripping.

### Example 6

### Distillation of Ethyl Esters from a Sunflower DD—Step b.2)

750 grams of residue obtained after stripping (Example 5) are continuously introduced onto a thin layer evaporator with a scraped film, connected to a rectification column. The introduction flow rate corresponds to 150 grams per hour. The column has a height of 80 cm of BX Sulzer type packing with a diameter of 60 mm. The thereby configured system provides ten theoretical plates. The evaporator is heated to 230° C. The column head temperature is maintained at 205° C. Ester reflux is used in a vacuum comprised between 20 to 30 mbars. The major portion of the ethyl esters is distilled. The obtained distillate in majority consists of esters (97%), traces of free fatty adds (0.3%). The remainder consists of hydrocarbons (2.4%) and of squalene (0.2%). The distillate represents 456.9 grams, i.e. 60.9% of the product which enters the distillation system. The residue (40% of incoming product) consists of 103 grams of esters, 42.7 grams of squalene, 30.6 grams of hydrocarbons, 14.9 grams of vitamin E, 90.4 grams of sterols and of triterpene alcohols and 11.4 grams of impurities.

### Example 7

### Distillation of Heavy Ethyl Esters and of Squalene from a Sunflower DD—Step b.3)

The residue of Example 6 is introduced into the same system with a scraped film as described in Example 6 with a rectification column having ten theoretical plates, at a flow rate of 150 grams per hour, for a controlled temperature of the evaporation chamber comprised between 230° C. to 245° C., in a vacuum comprised between 1 to 5 mbars. The column head temperature is maintained at 220° C. A distillate fraction is obtained with the following composition:

| | Distilled Fraction | | Residual Fraction | |
|---|---|---|---|---|
| | mass (g) | relative % | mass (g) | % |
| Compounds | of each compound | | of each compound | |
| Squalene | 40.1 | 23.9% | 2.6 | 2.1% |
| Ethyl esters | 100.1 | 59.7% | 2.9 | 2.3% |
| Hydrocarbons | 25.1 | 14.9% | 5.5 | 4.4% |
| Vitamin E | 0.2 | 0.1% | 14.7 | 1.7% |
| Impurities | 0.8 | 0.5% | 10.6 | 8.5% |
| Sterols and triterpene | — | — | 89 | 71% |
| alcohols | | | | |
| Free Fatty Acids | 1.4 | 0.8% | — | — |
| | 167.7 | 100% | 125.3 | 100% |

### Example 8

### Glycerolysis of Ethyl Esters of the Distillate of Example 7 and Distillation of the Glycerolyzed Product—Step e)

165 grams of the distillate of Example 7 are introduced into a reactor provided with vane stirrer, with a jacket, with a fractionation column. The distillate of Example 7 is glycerolyzed in the presence of 10.2 grams of glycerol and 0.05% of 50% soda lye relatively to the introduced amount of distillate. The reaction is carried out in a vacuum from 10 to 30 mbars, by gradually heating up to 210° C. in the bulk. Under these conditions, within eight hours, 99% of the initially present ethyl esters are converted into triglycerides, i.e. 106.3 grams of converted esters.

The glycerolyzed product contains 95.3 grams of triglycerides, 40 grams of non-isomerized squalene and further 1.1 grams of residual ethyl esters. It is introduced into a molecular distillation system (UIC KDL1 model) at a flow rate of 150 grams per hour, in a vacuum comprised between 0.1 and 0.05 mbars, with a preheating temperature of 90° C. The evaporation chamber is maintained at 230° C., with 400 rpm stirring. The residue of this distillation contains 0.5% of squalene. In order to obtain high purity squalene, the distillate will have to be subject to saponification, winterization and stripping steps, . . .

### Example 9

### Purification of Squalene by Stripping the Vegetable Hydrocarbons—Step f)

The distillate of Example 8, purified by saponification in order to remove the traces of triglycerides and of esters is very rich in squalene. But it still contains 22% of hydrocarbons which will be essentially removed by stripping. Stripping of squalene is carried out on a column with twenty theoretical plates, in a vacuum from 4 to 8 mbars. The product is injected into the column head at a temperature of 215° C. Nitrogen is injected at the bottom of the column as a counter-current. The distillate still containing 20% of squalene is subject to a second passage over the stripping apparatus, with which it is still further possible to concentrate the non-squalene hydrocarbons. These hydrocarbons, relatively heavy (mainly from C₁₇ to C₂₂) are not very odorous, have a flash point above 100° C., a pour point of −5° C., which makes them suitable for use as solvents for crystallization of sterols.

### Example 10

### Obtaining Natural Vegetable Hydrocarbons During the Stripping Operation of the Squalene—Step g)

39.1 grams of the distillate of Example 5 containing 69.8% of non squalene hydrocarbons, 21% of fatty acid ethyl esters, 2.8% of free fatty acids, 5.4% of squalene are introduced into a reactor provided with vane stirring, a jacket, a thermostatic reflux column allowing release of the evolved alcohol, while condensing the hydrocarbons and the glycerol. The distillate of Example 5 is glycerolyzed in the presence of 0.87 grams of glycerol and 0.01% of 50% potash. The reaction is conducted in a vacuum of 50 mbars, by gradually heating up to 200° C. in the bulk. Under these conditions, within eight hours, 99% of initially present ethyl esters and free fatty acids are converted into triglycerides.

The product is then distilled on a column identical with the one of Example 5 in a vacuum from 5 to 7 mbars and having twenty theoretical plates. The flow rate is 200 grams/hour. Nitrogen is injected at the base of the column. The column head temperature is 125° C. The distillate consists of light hydrocarbons (C₈ to C₁₅), which are odorous and irritating, which will be removed. The residue mainly containing hydrocarbons and triglycerides is then distilled a second time on the same equipment with a column head temperature of 215° C. A distillate containing a fraction of hydrocarbons with carbon condensation mainly ranging from dodecane (C₁₂) to docosane (C₂₂) is thereby obtained. This second fraction of hydrocarbons will then be mixed with the fraction of hydrocarbons from Example 9 in order to be used during crystallization of the sterols.

### Example 11

### Crystallization of the Sterols in the Presence of Vegetable Hydrocarbons—Step c)

The distillation residue from Example 7 has the following composition:

| | Mass (g) | % |
|---|---|---|
| Squalene | 2.6 | 2.1% |
| EEAG | 2.9 | 2.3% |
| Heavy hydrocarbons | 5.5 | 4.4% |
| Tocopherols | 14.7 | 11.7% |
| Impurities | 10.6 | 8.5% |
| Sterols and triterpene alcohols | 89 | 71% |
| | 125.3 | 100% |

This residue is diluted at room temperature in 513.6 grams of vegetable hydrocarbons, which corresponds to a “bio solvent”/residue mass ratio of 4. The operation is performed in a crystallizer of 1 liter, equipped with a jacket, a stirring anchor, a temperature probe, a system allowing introduction of inert gas (nitrogen), and a connection for putting the crystallizer in vacuo. The medium is put under a primary vacuum of 50 mbars and with stirring (200 rpm), and then gradually heated up to 80° C. Gradual cooling is then carried out, with a rate of 10° C. per hour down to room temperature (25° C.) with slight stirring (100 rpm) in order to promote growth of crystals. After one night, the crystals are filtered by incorporating 2% of dicalite before having them pass over the filter press. When the crystallization cake is well dewatered, the mixture of crystals and dicalite is recovered, and then melted in a small reactor, in vacuo, and then refiltered in order to recover the crystals of sterols and triterpene alcohols. The winterization cake allows recovery of 84.5 grams of sterols (i.e. 95% of the amount initially present before this first winterization). Also 1.1 grams of impurities, 0.2 grams of tocopherols and 1.2 grams of esters are also recovered in these crystals

### Example 12

### Second Crystallization of the Filtrate Stemming from the First Crystallization of the Sterols—Step c)

The filtrate dissolved in vegetable hydrocarbons from Example 11 containing the remainder of the vitamin E (14.5 grams), of sterols (4.5 grams), 1.7 grams of ethyl esters and different impurities (oxidative and thermal degradation products, carbonyl products) is taken up under the same conditions as in Example 11, and it is then crystallized for 10 hours at 0° C. 98% of the amount of sterols present at the beginning of Example 11 were recovered in the filtration cake. The filtration cake is mixed with the filtration cake from the first winterization.

### Example 13

### Extraction of Vitamin E from the Winterization Filtrates of the Sterols—Step d)

The filtrates of two successive crystallizations contain vitamin E, traces of esters, and impurities, the whole dissolved in the vegetable hydrocarbons. This filtrate is subject to distillation on the reactor used in Examples 6 and 7: thin film evaporator with a scraped film, connected to a rectification column with 10 plates, with which hydrocarbons and residual esters may be removed. The column is heated to about 200° C. in a vacuum of 1 mbar. The system, because of its thin film configuration gives the possibility of not degrading vitamin E. The residue of this first distillation is then distilled by molecular distillation. The evaporation chamber was maintained at 230° C., in a vacuum of 0.01 mbars, with 400 rpm stirring. With the distillation it is possible to obtain a distillate which is highly enriched with vitamin E and a concentration of heavy impurities in the residue. The filtrate, very rich in vitamin E but still containing impurities may be purified according to known techniques, notably by having it pass over anionic resins after dissolution in bio-ethanol.

1. A method for extracting squalene, sterols and vitamin E contained in physical refining condensates and/or in deodorization distillates of vegetable oils, said method comprising the following steps:
a) conversion of the fatty acids, of the glycerides and the sterides contained in said condensates and/or said distillates, in order to obtain a product based on alkyl esters, squalene, vegetable hydrocarbons, sterols and vitamin E,
b) staged distillation of the product obtained in step a), established for recovering a concentrate of sterols and vitamin E on the one hand and a concentrate of alkyl esters, squalene and vegetable hydrocarbons on the other hand,
c) crystallization of the concentrate of sterols and of vitamin E obtained in step b), by mixing with hydrocarbons, in order to recover the sterols on the one hand and a concentrate of vitamin E in solution in said hydrocarbons on the other hand,
d) distillation of the concentrate of vitamin E in solution in the hydrocarbons obtained in step c), established for recovering vitamin E,
e) conversion of the alkyl esters of the concentrate obtained in step b) into triglycerides followed by a distillation established for separating said triglycerides from squalene and from vegetable hydrocarbons,
f) distillation of the product obtained in step e), established for extracting squalene from the vegetable hydrocarbons.

2. The method according to claim 1, wherein the vegetable hydrocarbons separated at the end of step f) are used for participating in the crystallization of the sterols in step c).

3. The method according to claim 1, wherein step b) is achieved by carrying out:
b.1) a first distillation established for extracting a fraction of the vegetable hydrocarbons and a fraction of the alkyl esters,
b.2) a second distillation established for extracting the majority of the alkyl esters from the residue obtained in step a),
b.3) a third distillation established for carrying away residual alkyl esters, squalene and residual vegetable hydrocarbons, without carrying away sterols and vitamin E which are less volatile.

4. The method according to claim 3, wherein the first distillation is achieved on a filled column representing the equivalent of twenty theoretical plates, in a vacuum comprised between 3 mbars and 10 mbars, preferentially between 4 mbars and 7 mbars, at a heating temperature comprised between 160° C. and 180° C., and a column head temperature comprised between 120° C. and 150° C., preferentially between 140° C. and 145° C.

5. The method according to claim 3, wherein the second distillation is achieved on a filled column representing the equivalent of ten theoretical plates, in a vacuum comprised between 10 mbars and 40 mbars, preferentially between 20 mbars and 30 mbars, at a heating temperature comprised between 220° C. and 250° C., preferentially 230° C., and a column head temperature comprised between 180° C. and 220° C., preferentially between 200° C. and 205° C.

6. The method according to claim 3, wherein the third distillation is achieved on a filled column representing the equivalent of ten theoretical plates, in a vacuum comprised between 1 mbar and 10 mbars, preferentially between 2 mbars and 5 mbars, at a heating temperature comprised between 220° C. and 260° C., preferentially between 240° C. and 250° C., and at a column head temperature comprised between 200° C. and 250° C., preferentially between 220° C. and 230° C.

7. The method according to claim 3, further including the steps:
g.1) converting the fraction of alkyl esters extracted in step b1) into triglycerides
g.2) distilling the product obtained at the end of step g.1), established for separating said triglycerides from vegetable hydrocarbons.

8. The method according to claim 7, wherein the vegetable hydrocarbons separated at the end of step g.2) are combined with hydrocarbons separated at the end of step f), the whole being used for crystallizing sterols in step c).

9. The method according to claim 1, wherein step a) is achieved via:
esterification of the fatty acids with a short alcohol, selected from primary and secondary C1-C3 alcohols and in the presence of an acid catalyst,
trans-esterification of the glycerides and sterides with a short alcohol, selected from primary and secondary C1-C3 alcohols and in the presence of a basic catalyst.

10. The method according to claim 9, wherein esterification is achieved under the following conditions:
an amount of acid catalyst of less than 0.1% relatively to the mass of the condensates and/or of the distillates to be esterified,
the reaction temperature is less than 95° C.,
the esterification alcohol is in molar excess in a ratio of more than 5 relatively to the fatty acids,
the acid catalyst is totally neutralized at the end of esterification.

11. The method according to claim 9, wherein trans-esterification is achieved under the following conditions:
the reaction temperature is less than 100° C.,
the basic catalyst is totally neutralized at the end of trans-esterification.

12. The method according to claim 9, wherein trans esterification and esterification are both achieved with ethanol of vegetable origin.

13. The method according to claim 1, wherein prior to step f), squalene and hydrocarbons separated at the end of step e) are saponified in order to remove possible residual saponifiable products.

14. The method according to claim 1, wherein step f) is achieved by distillation on a column with a height equivalent to twenty theoretical plates, in a vacuum comprised between 2 mbars and 10 mbars, preferentially between 4 mbars and 8 mbars, the product to be treated being injected into the column head at a temperature comprised between 200° C. and 230° C., preferentially 215° C., nitrogen being simultaneously injected at the bottom of the column for counter current operation.

15. The method according to claim 14, wherein the distilled hydrocarbons still containing a squalene fraction, are reinjected into the column until a squalene percentage of less than 10% is obtained.

16. The method according to claim 1, wherein a winterization step is carried out on the squalene obtained at the end of step f).

17. The method according to claim 1, wherein the distillation of step d) is achieved on a filled column representing the equivalent of ten theoretical plates, in a vacuum comprised between 0.2 mbars and 5 mbars, preferentially 1 mbar, at a heating temperature comprised between 200° C. and 240° C., preferentially 220° C., and at a column head temperature comprised between 180° C. and 220° C., preferentially 200° C.
